(19) United States
(12) Patent Application Publication
(10) Pub. No.: US 2026/0088644 A1
(43) Pub. Date: Mar. 26, 2026

(54) ELECTRIC POWER SYSTEM

(71) Applicant: TOYOTA JIDOSHA KABUSHIKI KAISHA, Toyota-shi (JP)

(72) Inventors: Hiroaki TOYODA, Mishima-shi (JP); Hiroshi Morita, Susono-shi (JP); Kazuma Fujiwara, Kobe-shi (JP)

(73) Assignee: TOYOTA JIDOSHA KABUSHIKI KAISHA, Toyota-shi (JP)

(21) Appl. No.: 19/217,249

(22) Filed: May 23, 2025

(30) Foreign Application Priority Data
Sep. 25, 2024 (JP) 2024-166394

(51) Int. Cl. H02J 7/00; B60L 50/60; B60L 53/16; H02M 1/00; H02M 7/5387

(52) U.S. Cl. CPC H02J 7/855; B60L 50/60; B60L 53/16; H02J 7/575; H02J 7/82; H02M 1/0009; H02M 7/53871; B60L 2210/40

(57) ABSTRACT

The electric power system includes a first power storage device, a second power storage device where a second negative terminal is connected to the negative-side line, a series relay provided in a series line connecting the first negative terminal of the first power storage device and the second positive terminal of the second power storage device, a power storage system having a parallel relay provided in a parallel line connecting the first negative terminal and the negative-side line, a motor, first and second inverter units, and a changeover switch provided between the first and second inverter units of the positive-side line. The first inverter unit includes a three-level inverter having a first upper arm and a second lower arm of a third phase, and an intermediate potential switch of first, second capacitor, and three phases. The second positive terminal is connected to connection points of the first and second capacitors.

### CROSS-REFERENCE TO RELATED APPLICATION

This application claims priority to Japanese Patent Application No. 2024-166394 filed on Sep. 25, 2024. The disclosure of the above-identified application, including the specification, drawings, and claims, is incorporated by reference herein in its entirety.

### BACKGROUND

### 1. Technical Field

The present disclosure relates to an electric power system.

### 2. Description of Related Art

Conventionally, there has been proposed an electric power system including a power storage device, a motor having a three-phase open winding, a first inverter unit that is connected to a power line to which the power storage device is connected and that is also connected to one end side of the three-phase open winding, a second inverter unit that is connected a portion of the power line that is on an opposite side of a first inverter from the power storage device and that is also connected to another end side of the three-phase open winding, and a positive-side switch and a negative-side switch that are provided on a positive-side line and a negative-side line of the power line, between first and second inverters (e.g., see Japanese Unexamined Patent Application Publication No. 2018-14829 (JP 2018-14829 A)). In such an electric power system, Δ driving (H driving) for driving the motor by the first and second inverter units with the positive-side switch and the negative-side switch in an on state, and Y driving in which the other end side of the three-phase open winding is made to form a neutral point by the second inverter with the positive-side switch and the negative-side switch in an off state, and also the motor is driven by the first inverter unit, are switched and executed.

### SUMMARY

Consideration is being given to replacing the power storage device of the above-described electric power system with a power storage system including a first power storage device in which a first positive terminal is connected to a positive-side line, a second power storage device in which a second negative terminal is connected to a negative-side line, a series relay that is provided on a series line connecting a first negative terminal of the first power storage device and a second positive terminal of the second power storage device, and a parallel relay that is provided on a parallel line connecting the first negative terminal and the negative-side line. Further, connecting a connector that is connectable to an external direct current power source to a portion of the positive-side line and the negative-side line that is between the power storage system and the first inverter unit, connecting the second positive terminal and a portion of the positive-side line in a vicinity of the second inverter unit by a relay line, and providing a second parallel relay to the relay line, is being considered. In such a configuration, setting the series relay to an off state and also setting the parallel relay and the second parallel relay to an on state enables the first and second power storage devices to be parallel-connected to the connector and charged. However, such a configuration requires the second parallel relay. Accordingly, there is demand for conceiving a configuration in which the first and second power storage devices are connected in parallel to the connector and the first and second power storage devices can be charged, even without providing the second parallel relay. The electric power system of the present disclosure can provide a configuration in which the first and second power storage devices are connected in parallel to the connector and the first and second power storage devices can be charged.

The electric power system of the present disclosure adopts the following measures.
[1] The gist of the present disclosure is an electric power system that includes
   a power storage system that includes a first power storage device of which a first positive terminal is connected to a positive-side line, a second power storage device of which a second negative terminal is connected to a negative-side line, a series relay that is provided on a series line connecting a first negative terminal of the first power storage device and a second positive terminal of the second power storage device, and a parallel relay that is provided on a parallel line connecting the first negative terminal and the negative-side line,
   a motor that includes an open winding of three phases,
   a first inverter unit that is connected to the positive-side line and the negative-side line that is also connected to one end side of the open winding of the three phases,
   a second inverter unit that is connected to a portion of the positive-side line and the negative-side line on an opposite side of the first inverter unit from the power storage system, and that is also connected to another end side of the open winding of the three phases,
   a changeover switch that is provided on a portion of the positive-side line that is between the first and second inverter units, and
   a connector that is connected to a portion of the positive-side line and the negative-side line that is between the power storage system and the first inverter unit, and that is also connectable to an external direct current power source, in which
   the first inverter unit is equipped with a three-level inverter that includes a first upper arm and a first lower arm of the three phases that are connected in series with each other with respect to the positive-side line and the negative-side line for each of the phases, and also of which mutual connection points are correspondingly connected to the one end side of the open winding, first and second capacitors that are connected in series with each other with respect to the positive-side line and the negative-side line, an intermediate potential line of the three phases that connects each of the connection points of the first upper arm and the first lower arm of the three phases and a connection point of the first and second capacitors, and an intermediate potential switch of the three phases that are each provided on the intermediate potential line of the three phases,
   the second positive terminal is connected to the connection point of the first and second capacitors, and
   the second inverter unit is equipped with a two-level inverter that includes a second upper arm and a second lower arm of the three phases that are connected in series with each other with respect to the positive-side line and the negative-side line for each phase, and also of which mutual connection points are correspondingly connected to the other end side of the open winding.

According to this configuration, setting the series relay to an off state and also the parallel relay to an on state when the external direct current power source and the connector are connected enables the first and second power storage devices to be connected in parallel to the connector so as to charge the first and second power storage devices.
[2] The electric power system of the present disclosure (the electric power system according to [1] above) further includes a control device that, when performing parallel charging to charge the first and second power storage devices in parallel using electric power from the external direct current power source, with the series relay in an off state and also the parallel relay in an on state, sets the changeover switch, the intermediate potential switch of the three phases, and the second upper arm of the three phases to an on state, and also sets the first upper arm of the three phases, the first lower arm of the three phases, and the second lower arm of the three phases to an off state.
[3] The electric power system of the present disclosure (the electric power system according to [1] above) further includes a control device that, when performing parallel charging to charge the first and second power storage devices in parallel using electric power from the external direct current power source, with the series relay in an off state and also the parallel relay in an on state, sets the first upper arm of the three phases and the intermediate potential switch of the three phases to an on state, and also sets the changeover switch, the first lower arm of the three phases, the second upper arm of the three phases, and the second lower arm of the three phases to an off state.
[4] The electric power system of the present disclosure (the electric power system according to any one of [1] to [3] above) further includes a control device that, when transferring electric power from the first power storage device to the second power storage device, with the series relay in an off state and also the parallel relay in an on state, sets the changeover switch and the intermediate potential switch of the three phases to an on state, and also sets the first upper arm of the three phases and the first lower arm of the three phases to an off state, and also performs switching driving of the second upper arm of the three phases and the second lower arm of the three phases.
[5] The electric power system of the present disclosure (the electric power system according to any one of [1] to [4] above) further includes a control device that, when transferring electric power from the second power storage device to the first power storage device, with the series relay in an off state and also the parallel relay in an on state, sets the changeover switch to an off state, and also sets the intermediate potential switch of a particular phase of the three phases, the second upper arm of the particular phase, and the first upper arm of a remaining phase excluding the particular phase to an on state, and also sets the intermediate potential switch of the remaining phase, the second lower arm of the particular phase, the first upper arm of the particular phase, and the first lower arm of the three phases to an off state, and also performs switching driving of the second upper arm of the remaining phase and the second lower arm of the remaining phase.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of an electric power system and a charging station according to an embodiment;

FIG. 2 is an explanatory diagram illustrating a state of the first method in parallel charging;

FIG. 3 is an explanatory diagram illustrating a state of a second method in parallel charging;

FIG. 4 is an explanatory diagram showing a state of series charging;

FIG. 5 is an explanatory view showing a state of power transmission from the first battery to the second battery; and FIG. 6 is an explanatory diagram illustrating a state of power transmission from the second battery to the first battery.

### DETAILED DESCRIPTION OF EMBODIMENTS

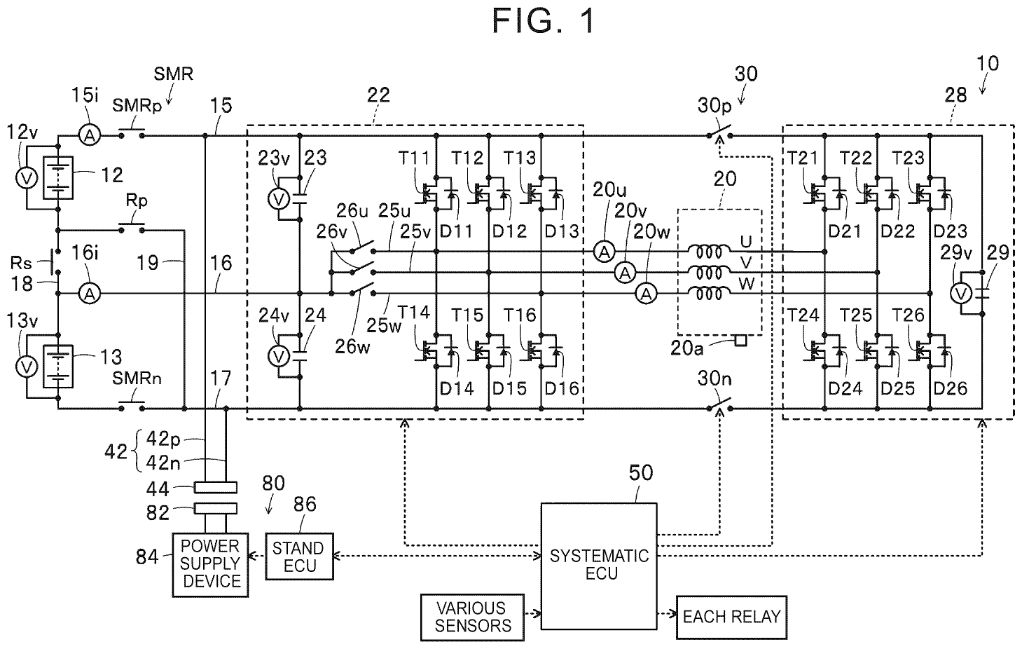

Embodiments for carrying out the present disclosure will be described with reference to the drawings. FIG. 1 is a schematic configuration diagram illustrating a schematic configuration of an electric power system 10 and a charging station 80 according to an embodiment of the present disclosure. As illustrated, the electric power system 10 of the embodiment includes a power storage system 11 including a first battery 12 (first power storage device) and a second battery 13 (second power storage device), a motor 20, and a first inverter unit 22. The electric power system 10 of the embodiment further includes a second inverter unit 28, a changeover switch 30, a system main relay SMR, a charging circuit 40, and an electronic control unit (hereinafter referred to as “ECU”) 50 as a control device. The electric power system 10 is mounted on a battery electric vehicle, a hybrid electric vehicle, fuel cell electric vehicle, or the like. The electric power system 10 is capable of charging the first and second batteries 12 and 13 of the power storage system 11 using electric power from a charging station 80 provided at a home, a charging station, or the like.

The power storage system 11 includes, in addition to the first and second batteries 12 and 13, a series relay Rs and a parallel relay Rp. Each of the first and second batteries 12 and 13 is configured as, for example, a lithium-ion secondary battery or a nickel-hydrogen secondary battery having a rated voltage of about a first voltage Vs1 (for example, several hundred V). In the embodiment, the first and second batteries 12 and 13 have the same specifications. The positive terminal (first positive terminal) of the first battery 12 is connected to the positive-side line 15. The negative terminal (first negative terminal) of the first battery 12 is connected to the positive terminal (second positive terminal) of the second battery 13 via the series line 18, and is connected to the negative-side line 17 via the parallel line 19. The positive terminal of the second battery 13 is connected to the first battery 12 via the series line 18, and is connected to the positive-side line 16. The negative terminal (second negative terminal) of the second battery 13 is connected to the negative-side line 17. The series relay Rs is provided in the series line 18. The parallel relay Rs is provided in the parallel line 19.

The motor 20 is configured as a three-phase AC motor, and includes a rotor in which permanent magnets are embedded in a rotor core, and a stator in which coils (open windings) of three phases (U-phase, V-phase, and W-phase) are wound around the stator core. The rotor is connected to a drive shaft connected to the drive wheels via a differential gear.

The first inverter unit 22 is connected to the positive-side lines 15 and 16 and the negative-side line 17. The first inverter unit 22 includes a T-type three-level inverter. Specifically, the first inverter unit 22 includes six transistors T11 to T16, six diodes D11 to D16 connected in parallel to T16 from the six transistors T11, two capacitors 23 and 24, a three-phase (U-phase, V-phase, and W-phase) intermediate potential line 25u, 25v, 25w, and a three-phase intermediate potential switch 26u, 26v, 26w. For the transistors T11 to T16, for example, MOSFET or IGBT is used. The transistors T11 to T16 are arranged two each in pairs so as to be on the source-side and the sink-side with respect to the positive-side line 15 and the negative-side line 17, respectively. The connection point of the transistor T11, T14, the connection point of the transistor T12, T15, and the connection point of the transistor T13, T16 are connected to one end side of the U-phase, V-phase, and W-phase coils of the motor 20, respectively. Hereinafter, T13 from the transistor T11 may be referred to as a “first upper arm”, and T16 from the transistor T14 may be referred to as a “first lower arm”. The capacitors 23 and 24 are connected in series to the positive-side line 15 and the negative-side line 17 in this order. Capacitors 23 and 24, those of the same specifications are used with each other. The connection points of the capacitors 23 and 24 are connected to the positive-side line 16. Intermediate potential line 25u, 25v, 25w of three phases, the connection point of the transistor T11, 14, the connection point of the transistor T12, T15, and the connection point of the transistor T13, T16, and a connection point of the capacitor 23 and 24, respectively. The three-phase intermediate potential switch 26u, 26v, 26w are respectively provided in the three-phase intermediate potential lines 25u, 25v, 25w. As the three-phase intermediate potential switch 26u, 26v, 26w, for example, a semiconductor switch, specifically, a wide bandgap semiconductor switch using gallium nitride (GaN) or silicon carbide (SiC) is used. The intermediate potential switch 26u may be configured such that the diodes are connected in series so as to be opposite to each other, for example, using two sets of transistors and diodes connected in parallel thereto. The same applies to the intermediate potential switch 26v, 26w.

The second inverter unit 28 is connected to a side of the positive-side line 15 and the negative-side line 17 opposite to the power storage system 11 with respect to the first inverter unit 22. The second inverter unit 28 includes a two-level inverter, and specifically includes six transistors T21 to T26, six diodes D21 to D26 connected in parallel to six transistors T21 to T26, and a capacitor 29. For the transistors T21 to T26, for example, MOSFET or IGBT is used. The transistors T21 to T26 are arranged two each in pairs so as to be on the source-side and the sink-side with respect to the positive-side line 15 and the negative-side line 17, respectively. The connection point of the transistor T21, T24, the connection point of the transistor T22, T25, and the connection point of the transistor T23, T26 are connected to the other ends of the U-phase, V-phase, and W-phase coils of the motor 20, respectively. Hereinafter, T23 from the transistor T21 may be referred to as a “second upper arm”, and T26 from the transistor T24 may be referred to as a “second lower arm”. The capacitor 29 is connected to the positive-side line 15 and the negative-side line 17.

The changeover switch 30 includes a positive-side switch 30p and a negative-side switch 30n. The positive-side switch 30p is provided between the first and second inverter units 22 and 28 of the positive-side line 15. The negative-side switch 30n is provided between the first and second inverter units 22 and 28 of the negative-side line 17. Each of the positive-side switch 30p and the negative-side switch 30n is, for example, a semi-conductor switch. The positive-side switch 30p may be configured by, for example, using two sets of transistors and diodes connected in parallel thereto, and being connected in series so that the diodes are opposite to each other. The same applies to the negative-side switch 30n.

The system main relay SMR includes a positive-side relay SMRp and a negative-side relay SMRn. The positive-side relay SMRp is provided between the positive terminal of the first battery 12 of the positive-side line 15 and the first inverter unit 22. The negative-side relay SMRn is provided between the negative terminal of the second battery 13 of the negative-side line 17 and the first inverter unit 22.

The charging circuit 40 includes a charging line 42 and a charging connector 44. The charging line 42 has a charging positive-side line 42p and a charging negative-side line 42n. The charging positive-side line 42p is connected between the first inverter unit 22 of the positive-side line 15 and the positive-side relay SMRp, and to the charging connector 44. The charging negative-side line 42n is connected between the first inverter unit 22 of the negative-side line 17 and the negative-side relay SMRn, and to the charging connector 44. The charging connector 44 is configured to be connectable to the stand connector 82 of the charging station 80.

ECU 50 includes a microcomputer having a CPU, ROM, RAM, a flash memory, an input/output port, and a communication port, various driving circuitry, and various logic IC. The system ECU 50 receives signals from various sensors. For example, the system ECU 50 receives the voltage Vb1 of the first battery 12 from the voltage sensor 12v, the voltage Vb2 of the second battery 13 from the voltage sensor 13v, the current Ip1 of the positive-side line 15 from the current sensor 15i, and the current Ip2 of the positive-side line 16 from the current sensor 16i. When the series relay Rs is in the off-state and the parallel relay Rp is in the on-state, the current Ip1, Ip2 of the positive-side lines 15 and 16 correspond to the currents of the first and second batteries 12 and 13, respectively. When the series relay Rs is in the on-state and the parallel relay Rs is in the off-state and the current Ip2 of the positive-side line 16 is 0, the current Ip1 of the positive-side line 15 corresponds to the currents of the first and second batteries 12 and 13. ECU 50 also receives the rotational position θm of the rotor of the motor 20 from the rotational position sensor 20a and the phase current Iu, Iv, Iw of each phase of the motor 20 from the current sensor 20u, 18v, 18w. The system ECU 50 also receives the voltage Vc1 of the capacitor 23 from the voltage sensor 23v, the voltage Vc2 of the capacitor 24 from the voltage sensor 24v, and the voltage Vc3 of the capacitor 29 from the voltage sensor 29v. The system ECU 50 also receives an on-off signal from the power switch, a shift position SP from the shift position sensor, an accelerator operation amount Acc from the accelerator pedal position sensor, a brake pedal position BP from the brake pedal position sensor, and a vehicle speed V from the vehicle speed sensor. The shift position SP is an operating position of the shift lever. The accelerator operation amount Acc is a depression amount of the accelerator pedal. The brake pedal position BP is a depression amount of the brake pedal.

ECU 50 calculates the power storage ratio SOC1, SOC2 of the first and second batteries 12 and 13, and calculates the electric angle θe and the rotational speed Nm of the motor 20. The power storage ratio SOC1, SOC2 of the first and second batteries 12 and 13 is calculated based on the status of the series relay Rs and the parallel relay Rp and the current Ip1, Ip2 of the first and positive-side lines 15 and 16. The electric angle θe and the rotational speed Nm of the motor 20 are calculated based on the rotational position θm of the rotor of the motor 20. Various control signals are outputted from the system ECU 50. For example, a control signal to the power storage system 11 (the series relay Rs and the parallel relay Rp) and a control signal to the first inverter unit 22 (the intermediate potential switch 26u, 26v, 26w of T16 and the three phases from the transistor T11) are outputted from the system ECU 50. The system ECU 50 further outputs a control signal to the second inverter unit 28 (from the transistor T21 to T26), a control signal to the changeover switch 30 (the positive-side switch 30p and the negative-side switch 30n), and a control signal to the system main relay SMR (the positive-side relay SMRp and the negative-side relay SMRn). ECU 50 is capable of communicating with a stand electronic control unit (hereinafter referred to as a “stand ECU”) 86 of the charging stand.

The charging station 80 includes a stand connector 82, a power supply device 84, and a stand ECU 86. The stand connector 82 is configured to be connectable to the charging connector 44 of the electric power system 10. The power supply device 84 is configured to be capable of converting AC power from an electric power system or the like into DC power and adjusting output power (output voltage or output current) to output the AC power to the stand connector 82 side. The stand ECU 86 includes a microcomputer, various driving circuitry, and various logic IC as in the case of the system ECU 50. The stand ECU 86 receives signals from various sensors. A control signal to the power supply device 84 is outputted from the stand ECU 86. The stand ECU 86 can communicate with the system ECU 50 as described above. Examples of the charging station 80 include a first type stand in which the output voltage is about the first voltage Vs1, a second type stand in which the output voltage is about the second voltage Vs2 (for example, two times the first voltage Vs1) higher than the first voltage Vs1, and a third type stand in which any of the first and second voltage Vs1, Vs2 can be selectively set as the output voltage.

In the electric power system 10 of the embodiment, the system ECU 50 may be connected to the charging connector 44 and the stand connector 82. At that time, when the output voltage of the charging station 80 is about the first voltage Vs1, parallel charging is selected, and when the output voltage of the charging station 80 is about the second voltage Vs2, series charging is selected. In both the parallel charge and the series charge, the positive-side relay SMRp and the negative-side relay SMRn are turned on with respect to the system main relay SMR.

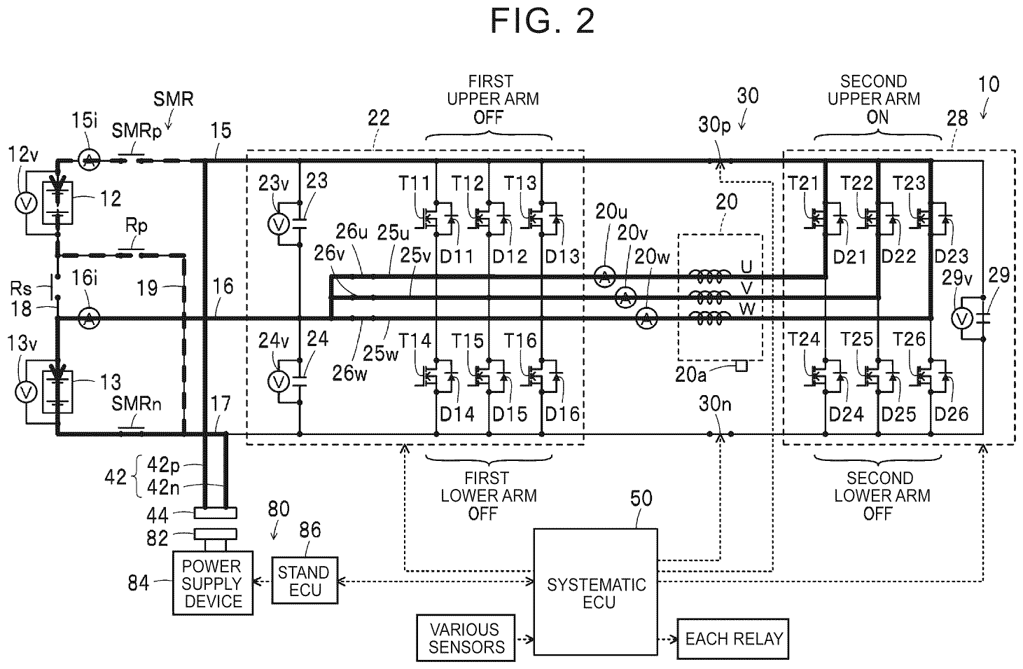

First, parallel charging will be described. As a method of parallel charging, a first method and a second method are exemplified. FIG. 2 is an explanatory diagram illustrating a state of the first method in parallel charging. In the drawing, a thick broken line with an arrow indicates a charging current of the first battery 12, and a thick solid line with an arrow indicates a charging current of the second battery 13. In the first method, the series relay Rs is turned off and the parallel relay Rp is turned on for the power storage system 11. With respect to the changeover switch 30, the positive-side switch 30p and the negative-side switch 30n are turned on. With respect to the first inverter unit 22, the first upper arm (from the transistor T11 to T13) of the three phases and the first lower arm (from the transistor T14 to T16) of the three phases are turned off, and the intermediate potential switch 26u, 26v, 26w of the three phases is turned on. In the second inverter unit 28, the second upper arm of three phases (from the transistor T21 to T23) is turned on and the second lower arm of three phases (from the transistor T24 to T26) is turned off. Thus, as can be seen from FIG. 2, the first and second batteries 12 and 13 are connected in parallel to the charging connector 44.

In the first method, as shown by a thick broken line with arrows in FIG. 2, the first battery 12 is charged by a current flowing from the charging connector 44 through the paths of the charging positive-side line 42p, the positive-side line 15 (positive-side relay SMRp), the first battery 12, the parallel line 19 (parallel relay Rp), the negative-side line 17, the charging negative-side line 42n, and the charging connector 44. Further, as shown in the bold solid line with arrows in FIG. 2, the second battery 13, the charging positive-side line 42p from the charging connector 44, the positive-side line 15, the third phase second upper arm, the three-phase coil of the motor 20, the three-phase intermediate potential line 25u, 25v, 25w (three-phase intermediate potential switch 26u, 26v, 26w), the positive-side line 16, the second battery 13, the negative-side line 17 (negative-side relay SMRn), the negative-side line 42n for charging, is charged by the current flowing in the path of the charging connector 44. Note that the second inverter unit 28 may switch and drive the second upper arm of three phases and the second lower arm of three phases instead of turning on the third-phase second upper arm and turning off the third-phase second lower arm. In this configuration, T26 and the motor 20 function as a three-phase step-down converter from the transistor T21 of the second inverter unit 28.

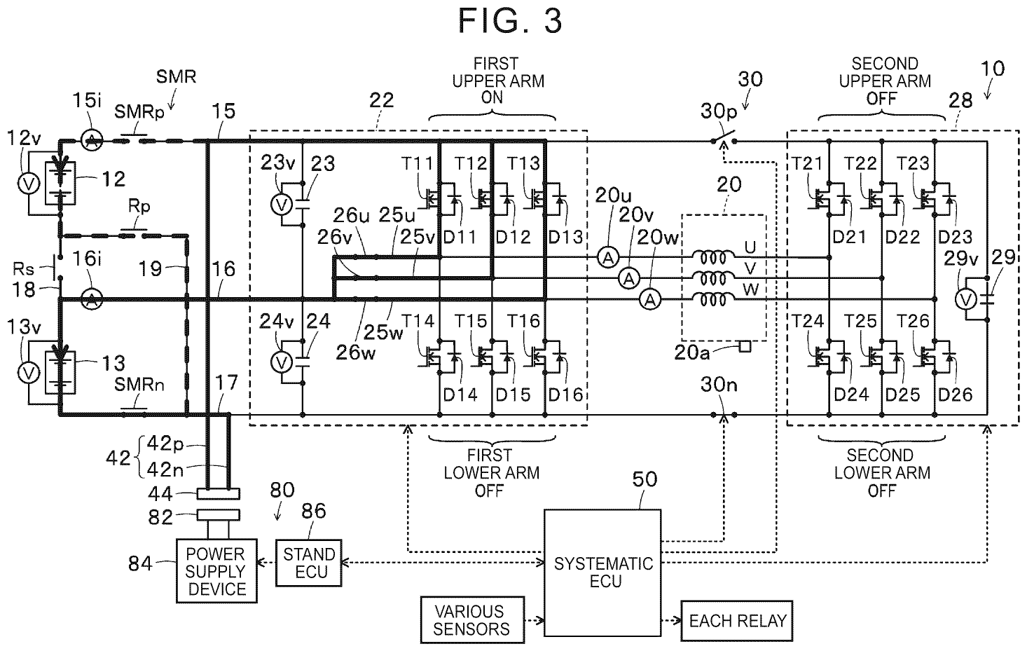

Next, the second method will be described. FIG. 3 is an explanatory diagram illustrating a state of the second method in parallel charging. In the drawing, a thick broken line with an arrow indicates a charging current of the first battery 12, and a thick solid line with an arrow indicates a charging current of the second battery 13. In the second method, the series relay Rs is turned off and the parallel relay Rp is turned on for the power storage system 11. With respect to the changeover switch 30, the positive-side switch 30p is turned off and the negative-side switch 30n is turned on. With respect to the first inverter unit 22, the first upper arm (from the transistor T11 to T13) of the three phases is turned on. In the first inverter unit 22, the first lower arm of the three phases (from the transistor T14 to T16) is turned off and the intermediate potential switch 26u, 26v, 26w of the three phases is turned on. With respect to the second inverter unit 28, the second upper arm of three phases (T23 from the transistor T21) and the second lower arm of three phases (T26 from the transistor T24) are turned off. Thus, as can be seen from FIG. 3, the first and second batteries 12 and 13 are connected in parallel to the charging connector 44.

In the case of the second method, the first battery 12 is charged by the current flowing in the same manner as in the first method, as shown by the thick broken line with arrows in FIGS. 2 and 3. Further, as shown in the bold solid line with arrows in FIG. 3, the second battery 13, the charging positive-side line 42p from the charging connector 44, the positive-side line 15, the first upper arm of the three phases, the three-phase intermediate potential line 25u, 25v, 25w (three-phase intermediate potential switch 26u, 26v, 26w), the positive-side line 16, the second battery 13, the negative-side line 17 (negative-side relay SMRn), the negative-side line 42n for charging, is charged by the current flowing in the path of the charging connector 44. In the second method, the negative-side switch 30n may be turned off.

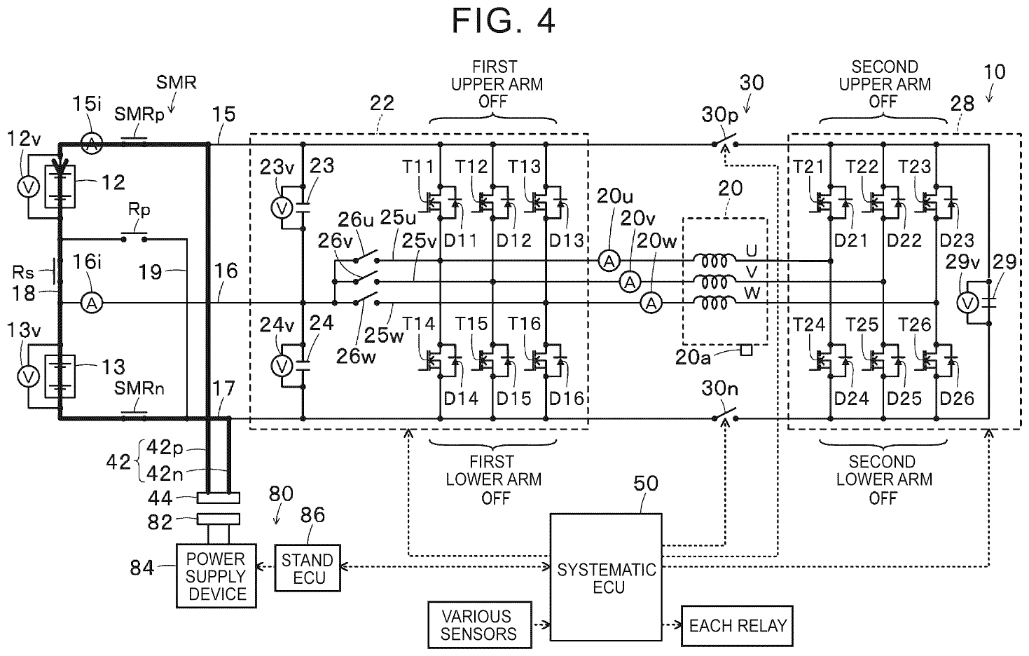

Next, series charging will be described. FIG. 4 is an explanatory diagram illustrating a state of series charging. In the drawing, a thick solid line with an arrow indicates the charging current of the first and second batteries 12 and 13. When the power storage system 11 is charged in series, the series relay Rs is turned on and the parallel relay Rp is turned off. With respect to the changeover switch 30, the positive-side switch 30p and the negative-side switch 30n are turned off. With respect to the first and second inverter units 22 and 28, all of the first upper arm (from the transistor T11 to T13) of the three phases, the first lower arm (from the transistor T14 to T16) of the three phases, the intermediate potential switch 26u, 26v, 26w of the three phases, the second upper arm (from the transistor T21 to T23) of the three phases, and the second lower arm (from the transistor T24 to T26) of the three phases are turned off. Thus, the first and second batteries 12 and 13 are connected in series. In this case, as shown in the bold solid line with arrows in FIG. 4, the first and second batteries 12 and 13 are charged by a current flowing from the charging connector 44 in the path of the charging positive-side line 42p, the positive-side line 15 (positive-side relay SMRp), the first battery 12, the series line 18 (series relay Rs), the second battery 13, the negative-side line 17, the charging negative-side line 42n, and the charging connector 44.

In addition, in the electric power system 10 of the embodiment, there may be a case where a reduction in the difference in the power storage ratio SOC1, SOC2 and the voltage Vb1, Vb2 of the first and second batteries 12 and 13 is required, a case where a temperature increase of at least a part of the motor 20, the first and second inverter units 22 and 28, the first and second batteries 12 and 13 is required, and the like. At this time, power transmission is performed between the first and second batteries 12 and 13. At the time of such power transmission, the positive-side relay SMRp and the negative-side relay SMRn are turned on for the system main relay SMR. At the time of such power transmission, the series relay Rs is turned off and the parallel relay Rp is turned on for the power storage system 11.

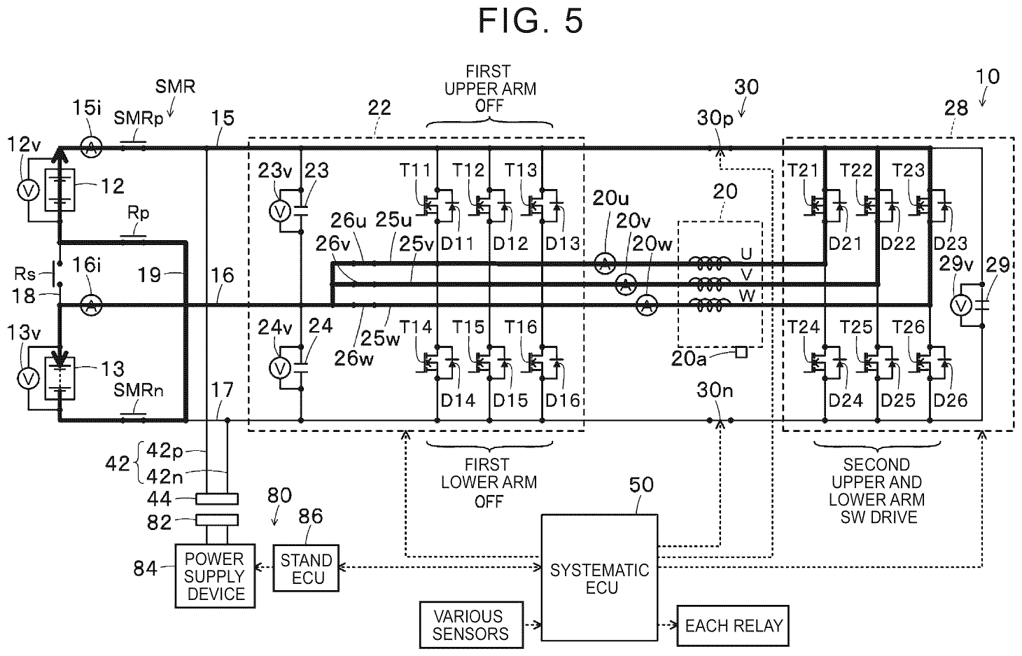

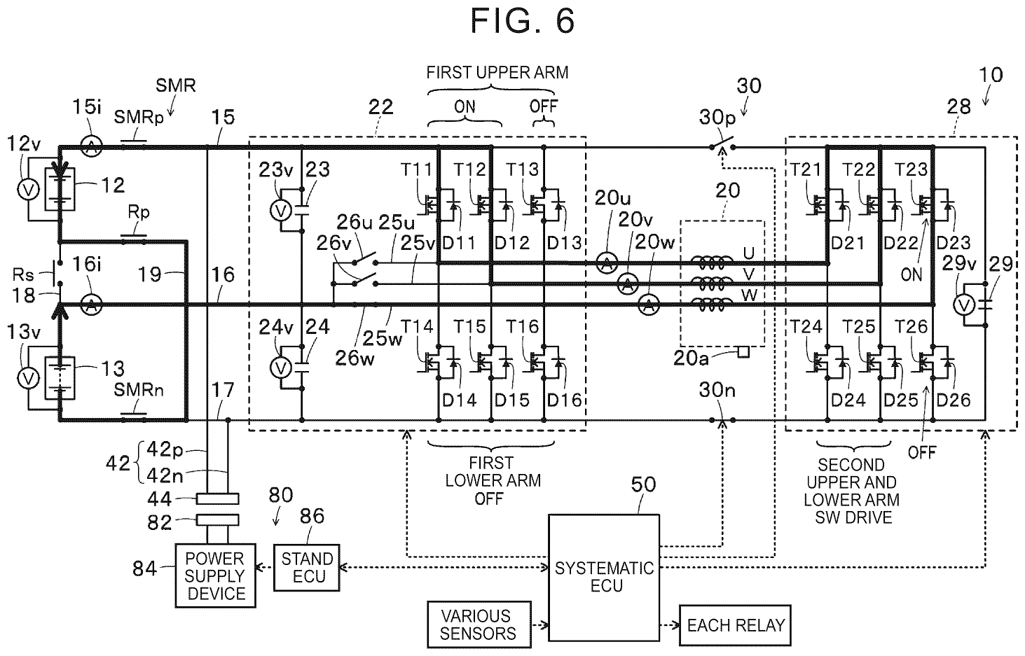

First, power transmission from the first battery 12 to the second battery 13 will be described. FIG. 5 is an explanatory diagram illustrating a state of the power transmission. In the drawing, a thick solid line with an arrow indicates a current flow in this power transmission. This power transmission is performed when the voltage Vb1 of the first battery 12 is higher than the voltage Vb2 of the second battery 13. In this power transmission, the positive-side switch 30p and the negative-side switch 30n are turned on with respect to the changeover switch 30. With respect to the first inverter unit 22, the first upper arm (from the transistor T11 to T13) of the three phases and the first lower arm (from the transistor T14 to T16) of the three phases are turned off, and the intermediate potential switch 26u, 26v, 26w of the three phases is turned on. The second inverter unit 28 switches and drives the second upper arm of three phases (T23 from the transistor T21) and the second lower arm of three phases (T26 from the transistor T24). Thus, T26 and the motor 20 function as three-phase step-down converters from the transistor T21 of the second inverter unit 28. Power transmission from the first battery 12 to the second battery 13 is performed by a current flowing from the first battery 12 to the positive-side line 15 (positive-side relay SMRp, positive-side switch 30p), the third-phase second upper arm, the three-phase coil of the motor 20, the three-phase intermediate potential line 25u, 25v, 25w (three-phase intermediate potential switch 26u, 26v, 26w), the positive-side line 16, the second battery 13, the negative-side line 17 (negative-side relay SMRn), the parallel line 19 (parallel relay Rp), and the path of the first battery 12, as shown by a thick solid line with an arrow in FIG. 5.

Next, power transmission from the second battery 13 to the first battery 12 will be described. FIG. 6 is an explanatory diagram illustrating a state of the power transmission. In the drawing, a thick solid line with an arrow indicates a current flow in this power transmission. This power transmission is performed when the voltage Vb2 of the second battery 13 is higher than the voltage Vb1 of the first battery 12. In this power transmission, the positive-side switch 30p is turned off and the negative-side switch 30n is turned on for the changeover switch 30. With respect to the first inverter unit 22, the specific phase (W phase in the example of FIG. 6) among the three-phase intermediate potential switch 26u, 26v, 26w is turned on, and the remaining phase (U phase and V phase in the example of FIG. 6) excluding the specific phase is turned off. In addition, with respect to the first inverter unit 22, the remaining phase among the first upper arms (the transistors T11 to T13) of the three phases is turned on, the particular phase is turned off, and the second lower arm (the transistors T14 to T16) of the three phases is turned off. With respect to the second inverter unit 28, the second upper arm of the specific phase is turned on and the second lower arm of the specific phase is turned off, and the second upper arm and the second lower arm of the residual phase are switched and driven. As a result, the second upper arm and the second lower arm of the remaining phase of the second inverter unit 28 and the remaining phase of the motor 20 function as a two-phase step-down converter. Power transmission from the second battery 13 to the first battery 12 in the example of FIG. 6, The intermediate potential line 25w of the positive-side line 16 and W phase (intermediate potential switch 26w of W phase) from the second battery 13, The W phase coil of the motor 20, the W phase second upper arm (transistor T13), The positive-side switch 30p of the positive-side line 15, the second inverter unit 28 side of the U phase and V phase of the second upper arm (transistor T21, T22), The path of the U phase of the motor 20, the V phase, the first upper arm (transistor T11, T12) of the V phase, U phase, the first inverter unit 22 side (positive-side relay SMRp) rather than the positive-side switch 30p of the positive-side line 15, the first battery 12, the parallel line 19 (parallel relay Rp), the negative-side line 17, and the second battery 13 It is caused by the flowing current. Note that, in the example of FIG. 6, the specific phase is W phase, the residual phase is U phase, and the V phase, but the present disclosure is not limited thereto, and the specific phase may be U phase, the residual phase may be V phase, and the W phase, or the specific phase may be V phase, and the residual phase may be U phase and W phase. In addition, although two residual phases are provided, one phase may be provided.

By the power transmission between the first and second batteries 12 and 13, it is possible to reduce the differences in the power storage ratio SOC1, SOC2 and the voltage Vb1, Vb2 of the first and second batteries 12 and 13, and to raise the temperatures of the motor 20, the first and second inverter units 22 and 28, the first and second batteries 12 and 13 by generating heat.

In the above-described embodiment, the changeover switch 30 includes the positive-side switch 30p and the negative-side switch 30n, but may include only the positive-side switch 30p.

Hereinafter, while embodiments for carrying out the present disclosure are described by using embodiments, it is needless to say that the present disclosure is not limited to such embodiments, and can be implemented in various forms without departing from the gist of the present disclosure.

The present disclosure is applicable to a manufacturing industry of an electric power system and the like.

What is claimed is:

1. An electric power system, comprising:
a power storage system that includes a first power storage device of which a first positive terminal is connected to a positive-side line, a second power storage device of which a second negative terminal is connected to a negative-side line, a series relay that is provided on a series line connecting a first negative terminal of the first power storage device and a second positive terminal of the second power storage device, and a parallel relay that is provided on a parallel line connecting the first negative terminal and the negative-side line;
a motor that includes an open winding of three phases;
a first inverter unit that is connected to the positive-side line and the negative-side line that is also connected to one end side of the open winding of the three phases;
a second inverter unit that is connected to a portion of the positive-side line and the negative-side line on an opposite side of the first inverter unit from the power storage system, and that is also connected to another end side of the open winding of the three phases;
a changeover switch that is provided on a portion of the positive-side line that is between the first and second inverter units; and
a connector that is connected to a portion of the positive-side line and the negative-side line that is between the power storage system and the first inverter unit, and that is also connectable to an external direct current power source, wherein
the first inverter unit is equipped with a three-level inverter that includes a first upper arm and a first lower arm of the three phases that are connected in series with each other with respect to the positive-side line and the negative-side line for each phase, and also of which mutual connection points are correspondingly connected to the one end side of the open winding, first and second capacitors that are connected in series with each other with respect to the positive-side line and the negative-side line, an intermediate potential line of the three phases that connects each of the connection points of the first upper arm and the first lower arm of the three phases and a connection point of the first and second capacitors, and an intermediate potential switch of the three phases that are each provided on the intermediate potential line of the three phases,
the second positive terminal is connected to the connection point of the first and second capacitors, and
the second inverter unit is equipped with a two-level inverter that includes a second upper arm and a second lower arm of the three phases that are connected in series with each other with respect to the positive-side line and the negative-side line for each phase, and also of which mutual connection points are correspondingly connected to the other end side of the open winding.

2. The electric power system according to claim 1, further comprising a control device that, when performing parallel charging to charge the first and second power storage devices in parallel using electric power from the external direct current power source, with the series relay in an off state and also the parallel relay in an on state, sets the changeover switch, the intermediate potential switch of the three phases, and the second upper arm of the three phases to an on state, and also sets the first upper arm of the three phases, the first lower arm of the three phases, and the second lower arm of the three phases to an off state.

3. The electric power system according to claim 1, further comprising a control device that, when performing parallel charging to charge the first and second power storage devices in parallel using electric power from the external direct current power source, with the series relay in an off state and also the parallel relay in an on state, sets the first upper arm of the three phases and the intermediate potential switch of the three phases to an on state, and also sets the changeover switch, the first lower arm of the three phases, the second upper arm of the three phases, and the second lower arm of the three phases to an off state.

4. The electric power system according to claim 1, further comprising a control device that, when transferring electric power from the first power storage device to the second power storage device, with the series relay in an off state and also the parallel relay in an on state, sets the changeover switch and the intermediate potential switch of the three phases to an on state, and also sets the first upper arm of the three phases and the first lower arm of the three phases to an off state, and also performs switching driving of the second upper arm of the three phases and the second lower arm of the three phases.

5. The electric power system according to claim 1, further comprising a control device that, when transferring electric power from the second power storage device to the first power storage device, with the series relay in an off state and also the parallel relay in an on state, sets the changeover switch to an off state, and also sets the intermediate potential switch of a particular phase of the three phases, the second upper arm of the particular phase, and the first upper arm of a remaining phase excluding the particular phase to an on state, and also sets the intermediate potential switch of the remaining phase, the second lower arm of the particular phase, the first upper arm of the particular phase, and the first lower arm of the three phases to an off state, and also performs switching driving of the second upper arm of the remaining phase and the second lower arm of the remaining phase.
